(19) United States
(12) Patent Application Publication
(10) Pub. No.: US 2011/0037023 A1
(43) Pub. Date: Feb. 17, 2011

(54) Stabilised Aluminosilicate Slurries

(76) Inventors: Simon Richard Stebbing, Cheshire (GB); Alexis J. Toft, Cheshire (GB); Stephen George Ellison, Cheshire (GB)

Correspondence Address: BUCHANAN INGERSOLL & ROONEY PC, P.O. BOX 1404, ALEXANDRIA, VA, 22313-1404, US

(21) Appl. No.: 12/912,867

(22) Filed: Oct. 27, 2010

Related U.S. Application Data
(63) Continuation of application No. 10/533,314, filed on Apr. 29, 2005, now abandoned.

(30) Foreign Application Priority Data
Oct. 30, 2002 (GB) 0225177.5

(51) Int. Cl. C09K 3/00

(52) U.S. Cl. 252/182.33

(57) ABSTRACT

An aqueous slurry according to the invention comprises (a) a crystalline aluminosilicate represented by the empirical formula

M_{2/n}O.Al₂O₃.xSiO₂.yH₂O

wherein M represents a first metal moiety, said first metal having a valency of n, x indicates the ratio of molecules of silica to molecules of alumina and y indicates the ratio of molecules of water to molecules of alumina, (b) a salt of a second metal selected from the group consisting of Group III metals, metallic elements of Group IV, magnesium, titanium, chromium, iron, nickel, copper, zinc, zirconium and silver, said salt of a second metal being present in an amount which is sufficient to replace from about 2.0 to about 40 per cent by weight of the first metal moiety, and (c) particulate silica having a BET surface area greater than 500 m²/g and a pore volume, as measured by nitrogen manometry of less than 2.1 cm³/g. The slurry is stable on storage but has a low viscosity at low shear rate.

### CROSS-REFERENCE TO RELATED APPLICATIONS

This application is a continuation of U.S. patent application Ser. No. 10/533,314 filed Apr. 29, 2005, which is the national Phase application of PCT International Patent Application No. PCT/GB2003/004593 filed Oct. 22, 2003, which designated the United States and was published in English and which is based on Great Britain Patent Application No. 0225177.5 filed Oct. 30, 2002. Each of the foregoing applications is hereby expressly incorporated by reference in its entirety.

This invention relates to aqueous slurries of crystalline aluminosilicates and in particular to crystalline aluminosilicate slurries having controlled rheological properties.

Crystalline aluminosilicates, or zeolites, have found use as fillers in such applications as the manufacture of paper. For such use, it is convenient to transport the zeolite in bulk in the form of an aqueous slurry. Particularly useful aqueous zeolite slurries having a relatively low pH value and containing a multivalent salt in addition to the zeolite are described in PCT application published as WO 01/94512. These slurries are stable and do not settle on standing but, because they have a lightly gelled structure, they can sometimes be difficult to fully discharge from a vessel.

An object of this invention is to provide a modified version of such a slurry having a structure which is resistant to settling but is readily capable of being discharged from a vessel.

According to the invention, an aqueous slurry comprises
(a) a crystalline aluminosilicate represented by the empirical formula

M_{2/n}O.Al₂O₃.xSiO₂.yH₂O

wherein M represents a first metal moiety, said first metal having a valency of n, x indicates the ratio of molecules of silica to molecules of alumina and y indicates the ratio of molecules of water to molecules of alumina,
(b) a salt of a second metal selected from the group consisting of Group III metals, metallic elements of Group IV, magnesium, titanium, chromium, iron, nickel, copper, zinc, zirconium and silver, said salt of a second metal being present in an amount which is sufficient to replace from about 2.0 to about 40 per cent by weight of the first metal moiety, and
(c) particulate silica having a BET surface area greater than 500 m²/g and a pore volume, as measured by nitrogen manometry of less than 2.1 cm³/g.

The above form of empirical formula is used for simplicity in expressing the molar ratios of the components, but it can be seen that the ratio of Si atoms to Al atoms in this formula is equal to x/2 and the ratio of water molecules to Al atoms is equal to y/2.

The first metal M can be any metal capable of forming a crystalline aluminosilicate structure having the above empirical formula. Preferably, M is an alkali metal and the preferred alkali metal is sodium.

The crystalline aluminosilicates used in the invention are usually known as zeolites and can have the structure of any of the known zeolites. The structure and characteristics of many zeolites are described in the standard work “Zeolite Molecular Sieves” by Donald W. Breck, published by Robert E. Krieger Publishing Company. Usually, the value of x in the above empirical formula is in the range 1.5 to 10. The value of y, which represents the amount of water contained in the voids of the zeolite, can vary widely. In anhydrous material y=0 and, in fully hydrated zeolites, y is typically up to 5.

Zeolites useful in this invention may be based on naturally-occurring or synthetic aluminosilicates and the preferred forms of zeolite have the structure known as zeolite P, zeolite X or zeolite A. Particularly preferred forms of zeolite are those disclosed in EP-A-0 384 070, EP-A-0 565 364, EP-A-0 697 010, EP-A-0 742 780, WO-A-96/14270, WO-A-96/34828 and WO-A- 97/06102, the entire contents of which are incorporated herein by this reference. The zeolite P described in EP-A-0 384 070 has the empirical formula given above in which M represents an alkali metal and x has a value up to 2.66, preferably in the range 1.8 to 2.66, and has a structure which is particularly useful in the present invention.

The preferred amount of the salt of a second metal used to prepare mixtures used in the invention depends upon a number of factors, such as the actual second metal selected, the actual crystalline aluminosilicate chosen and the desired effect to be achieved (in particular, the desired pH of the slurry). Useful mixtures contain an amount of second metal salt sufficient to replace from 3.0 to 30 per cent by weight of first metal, and, more preferably, from 3.0 to 20 per cent by weight of the first metal.

The appropriate amount of salt of a second metal in the mixture used in the invention, expressed in grams, depends upon the composition of the zeolite and the charge on the second metal but is readily calculated by a skilled person. For example, a zeolite having the empirical formula

Na₂O.Al₂O₃.2SiO₂

(anhydrous type A zeolite) contains 16.2 g of Na per 100 g of zeolite. An aluminium ion is capable of replacing three sodium ions. Hence, making allowance for the atomic weights of sodium and aluminium, it can be calculated that a mixture containing 100 g of anhydrous zeolite A and 0.317 g Al in the form of a suitable salt is a mixture suitable for use in the invention and containing sufficient salt of a second metal (i.e. aluminium) to replace 5 per cent by weight of the first metal moiety (i.e. sodium).

It has been observed that a salt of a second metal wherein the ion of the second metal has a relatively small size or a relatively high charge is more effective as a means of controlling the pH of the zeolite slurry. Consequently, the effect of the metal salt on the pH of the slurry is more marked when the salt of a second metal is a salt of aluminium than when it is a salt of magnesium and the effect is more marked for salts of magnesium than for salts of zinc. The preferred second metals for use in the invention are aluminium, zirconium and tin.

Slurries useful in the paper industry preferably have an approximately neutral pH. Particularly useful slurries of this invention contain an amount of the second metal which is sufficient to produce a slurry having a pH in the range 6 to 9, preferably in the range 7 to 9.

The particle size of the crystalline aluminosilicates used in the slurries of this invention is adjusted to suit the intended use. Typically, the volume average particle size will be greater than 0.1 μm and, usually, less than 20 μm. More preferably, the crystalline aluminosilicates will have a volume average particle size in the range 0.5 to 10 μm. For use as a filler for papers, the crystalline aluminosilicate preferably has a volume average particle size in the range 1 to 5 μm.

Various methods of assessing particle size are known and all give slightly different results. In the present invention, a size distribution is obtained by light scattering from particles dispersed by ultrasound in demineralised water using a Malvern Mastersizer®. The volume average particle size is the average particle size at 50 per cent cumulative volume as determined from the distribution.

The amount of crystalline aluminosilicate, expressed as dry weight of aluminosilicate present in the slurry is usually above 20 per cent by weight and often above 30 per cent by weight. The upper practical limit on the amount of aluminosilicate in the slurry will depend upon the viscosity of the slurry, which is likely to be too high for use in many applications when more than 65 per cent dry weight of aluminosilicate is present. Generally, useful slurries consisting essentially of crystalline aluminosilicate, salt of a second metal, silica and water, according to this invention, will contain not more than 50 per cent by weight of aluminosilicate (on a dry basis). For the purposes of this invention dry aluminosilicate is considered to be aluminosilicate which has been heated at 105° C. to constant weight.

The slurry of the invention contains a salt of a second metal as hereinbefore specified. Mixtures of more than one salt of a second metal (as defined) or salts of more than one second metal (as defined) can be used. Suitable salts include halides, such as chlorides (e.g. stannic chloride), nitrates, and, preferably, sulphates (e.g. aluminium sulphate, magnesium sulphate, zinc sulphate or zirconium sulphate).

The slurry also contains silica having a BET surface area greater than 500 m²/g. Preferably the silica has a BET surface area greater than 600 m²/g. Usually the surface area is less than 1200 m²/g.

The silica also has a pore volume as measured by nitrogen manometry of less than 2.1 cm³/g. Preferably, the pore volume is less than 1.2 cm³/g.

Preferably, the silica is silica gel or a precipitated silica.

The silica preferably has a volume average particle size in the range 0.5 to 30 μm, as measured by Malvern Mastersizer®. More preferably, the volume average particle size of the silica is in the range 2 to 15 μm.

The silica is preferably present in the slurry in an amount in the range 0.2 to 40 per cent by weight with respect to the dry weight of crystalline aluminosilicate. More preferably, the amount of silica present is in the range 0.5 to 15 per cent by weight with respect to dry weight of crystalline aluminosilicate and frequently, the amount of silica used is in the range 1.0 to 5.0 by weight with respect to dry weight of crystalline aluminosilicate.

The crystalline aluminosilicate used in the invention can be prepared by a conventional process. For example, a zeolite of type A can be prepared by mixing together sodium aluminate and sodium silicate at a temperature within the range of ambient temperature up to boiling point to form a gel, ageing the gel with stirring at a temperature usually in the range 70 to 95° C., separating the crystalline sodium aluminosilicate thus formed, washing, generally at a pH in the range 10 to 12.5, and drying. Zeolite of type P can be prepared by a similar process but zeolite type P formation is induced by the addition of type P seeds to the mixture of sodium aluminate and sodium silicate.

The slurry of the invention can be prepared in a number of ways. The crystalline aluminosilicate, salt of a second metal and water can be mixed in any order. A preferred method, however, comprises forming a solution of salt of a second metal at an appropriate concentration, adding the crystalline aluminosilicate with stirring and subsequently adding the silica, while the stirring is continued.

The following tests have been used in this invention.

### BET Surface Area and Pore Volume

Surface area of the silicas were measured using standard nitrogen adsorption methods of Brunauer, Emmett and Teller (BET) using a multi-point method with an ASAP 2400 apparatus supplied by Micromeritics of USA. The method is consistent with the paper by S. Brunauer, P. H. Emmett and E. Teller, J. Am. Chem. Soc., 60, 309 (1938). The pore volume was determined by a single point method as described in the operation manual for the ASAP 2400 apparatus. Samples are outgassed under vacuum at 27° C. for 1 hour before measurement at about −196° C.

### Volume Average Particle Size

The volume average particle size of the silica is determined using a Malvern Mastersizer® model S, with a 300 RF lens and MS17 sample presentation unit. This instrument, made by Malvern Instruments, Malvern, Worcestershire uses the principle of Fraunhofer diffraction, utilising a low power He/Ne laser. Before measurement the sample is dispersed ultrasonically at 25 W ultrasound power in demineralised water for 5 minutes to form an aqueous suspension. The Malvern Mastersizer® measures the volume particle size distribution of the silica. The volume average particle size (d₅₀) or 50 percentile is easily obtained from the data generated by the instrument. Other percentiles, such as the 90 percentile (d₉₀), are readily obtained.

The invention is illustrated by the following non-limiting examples.

### EXAMPLES

### Example 1

Three 100 g slurries were prepared with the compositions given in Table 1 below.

TABLE 1

| | Sample | | |
|---|---|---|---|
| | A | B | C |
| Demineralised Water | 57.8 | 57.8 | 57.8 |
| Al₂(SO₄)₃•14H₂O | 1.7 | 1.7 | 1.7 |
| Zeolite A24 (water content | 40.5 | 39.5 | 0 |
| 7.03% by drying at 105° C.) | | | |
| Zeolite A28 (water content | 0 | 0 | 39.5 |
| 13.35% by drying at 105° C.) | | | |
| Silica | 0 | 1.0 | 1.0 |

The amounts given above are parts by weight.

Zeolite A24 is a P type zeolite sold by INEOS Silicas Limited under the trade mark Doucil A24. It had a volume average particle size as measured by Malvern Mastersizer® of 1.5 μm.

Zeolite A28 is a P type zeolite sold by INEOS Silicas Limited under the trade mark Doucil A28. It had a volume average particle size as measured by Malvern Mastersizer® of 2.8 μm.

The silica was a silica gel sold by INEOS Silicas Limited under the Trade Name Sorbosil AC30. It had a volume average particle size of 7.9 μm, a pore volume to nitrogen of 0.39 cm³g⁻¹ and BET surface area of 725 m²g⁻¹.

Three small portions were taken from each of the slurries immediately after preparation and the rheological properties of the remaining slurries were determined using a Mettler Toledo RM 180 Rheomat rheometer, at 22±1° C., with a Mooney cup and bob geometry. The samples were shaken by hand prior to measurement but were not sheared vigorously. The rheometer programme consisted of shearing the sample at a set shear rate for 30 seconds, after which a shear stress measurement was taken at that shear rate. Measurements were taken at 10, 20, 30, 40, 60, 100, 200, 350 and 500 s⁻¹. The rheological properties of the small portions were similarly measured at 4 days, 24 days and 60 days after the slurries were prepared.

Sample A, initially and after storage, had a much higher viscosity than the other samples at all the measured shear rates. Importantly, the viscosity at low shear for Samples B and C was much lower than for Sample A. This is illustrated by the results for viscosity at a shear rate of 20 s⁻¹ shown in Table 2 below.

TABLE 2

| | | Sample | | |
|---|---|---|---|---|
| | | A | B | C |
| Viscosity | Initially | 0.55 | 0.06 | 0.02 |
| at 20 s⁻¹ | After 4 days | 0.58 | 0.06 | 0.10 |
| (Pa s) | After 24 | 0.62 | 0.15 | 0.07 |
| | days | | | |
| | After 60 | 0.69 | 0.25 | 0.12 |
| | days | | | |

All stock slurries showed a very slight sedimentation within 1 day, but this did not change on storage over 2 months.

Material similar to Sample A was stored in a large tank and it was found that it was difficult to satisfactorily discharge the bulk of the material from the tank. In contrast, material similar to Sample B was readily discharged from a tank after storage, leaving only a minimal heel.

### Example 2

100 g slurries were prepared with the compositions given in Table 3 below.

TABLE 3

| | Sample | | |
|---|---|---|---|
| | D | E | F |
| Demineralised Water | 58.0 | 57.6 | 57.6 |
| Al₂(SO₄)₃•14H₂O | 1.5 | 1.5 | 1.5 |
| Zeolite A24 (water content | 40.5 | 40.2 | 40.2 |
| 7.03% by heating at 105° C.) | | | |
| Silica - Sorbosil AC30 | — | 0.7 | — |
| Silica - Gasil ™ GM2 | — | — | 0.7 |

The amounts given above are parts by weight.

The zeolite and silica (Sorbosil AC30) were as used in Example 1. Gasil™ GM2 was a silica gel sold by INEOS Silicas Limited having a volume average particle size of 7.3 μm, a pore volume to nitrogen of 0.37 cm³g⁻¹ and a BET surface area of 691 m²g⁻¹.

The rheology profiles were measured as described in Example 1 on the samples 24 hours after preparation. The profiles of E and F were essentially similar to the profiles of Samples B and C, with Sample D being similar to Sample A. The viscosities at 20 s⁻¹ were as follows:

Sample D 0.54 Pa s

Sample E 0.01 Pa s

Sample F 0.01 Pa s.

### Example 3

1 Kg slurries were prepared with the compositions in Table 4

TABLE 4

| | Sample | | | |
|---|---|---|---|---|
| | G | H | I | J |
| Demineralised Water | 589.39 | 592.86 | 590.78 | 578.52 |
| Second metal salt | 15.91 | 12.44 | 14.52 | 26.78 |
| Zeolite A24 (water | 387.7 | 387.7 | 387.7 | 387.7 |
| content 3.6% by heating | | | | |
| at 105° C.) | | | | |
| Silica - Sorbosil AC30 | 7 | 7 | 7 | 7 |

The amounts given above are parts by weight.

The zeolite were as used in Example 1 except that the loss at 105 degrees C. for the A24 zeolite was 3.6%. The Sorbosil AC30 used in this Example had a volume average particle size of 8.1 μm, a pore volume to nitrogen of 0.40 cm³g⁻¹ and BET surface area of 724 m²g⁻¹.

The metal salt employed in each sample was as follows:

Sample G: Al₂(SO₄)₃.16 H₂O

Sample H: MgSO₄.7 H₂O

Sample I: ZnSO₄.7 H₂O

Sample J: Zr(SO₄)₂ solution

All of the salts were added as a solid except zirconium sulphate which was added as a 53.4 wt % solution, the amount of zirconium in this solution being determined using ICP atomic emission spectroscopy. The concentration of the metal cation coming from the added salt is the same in all slurries.

In addition to the above samples, 1 Kg slurries were prepared as specified in Table 4 except that the silica was omitted with corresponding adjustment of the demineralised water content—these are referred to below as samples Gc, Hc, lc and Jc.

Viscosity results (in Pa s) at a shear rate of 20 s⁻¹, obtained using the procedure described in example 1, are shown in Table 5 below for 4 days and 14 days (where available) after preparation of the slurries referred to above.

TABLE 5

| | Sample | | | | | | | |
|---|---|---|---|---|---|---|---|---|
| | G | Gc | H | Hc | I | Ic | J | Jc |
| 4 days | 0.06 | 0.40 | 0.07 | 0.34 | 0.02 | 0.31 | 0.04 | 0.36 |
| 14 days | 0.14 | 0.42 | 0.08 | 0.42 | — | — | — | — |

1. An aqueous slurry comprising
(a) a crystalline aluminosilicate represented by the empirical formula
M_{2/n}O-Al₂O₃-xSiO₂-yH₂O
wherein M represents a first metal moiety, said first metal having a valency of n, x indicates the ratio of molecules of silica to molecules of alumina and y indicates the ratio of molecules of water to molecules of alumina,
(b) a salt of a second metal selected from the group consisting of Group III metals, metallic elements of Group IV, magnesium, titanium, chromium, iron, nickel, copper, zinc, zirconium and silver, said salt of a second metal being present in an amount which is sufficient to replace from about 2.0 to about 40 per cent by weight of the first metal moiety, and
(c) particulate silica having a BET surface area greater than 500 m²/g and a pore volume, as measured by nitrogen manometry of less than 2.1 cm³/g,
wherein the amount of crystalline aluminosilicate present in the slurry is in the range 20 to 50 per cent by weight calculated as dry aluminosilicate.

2. The aqueous slurry of claim 1 wherein M is an alkali metal.

3. The aqueous slurry of claim 1 wherein M is sodium.

4. The aqueous slurry of claim 1 wherein the crystalline aluminosilicate is a zeolite P, zeolite A or zeolite X.

5. The aqueous slurry of claim 1 wherein the second metal is aluminium, zirconium or tin.

6. The aqueous slurry of claim 1 wherein it has a pH in the range 6 to 9.

7. The aqueous slurry of claim 1 wherein the crystalline aluminosilicate has a volume average particle size in the range 0.1 to 20 μm.

8. The aqueous slurry of claim 1 wherein the silica has a BET surface area greater than 600 m²/g.

9. The aqueous slurry of claim 1 wherein the silica has a pore volume of less than 1.2 cm³/g.

10. The aqueous slurry of claim 1 wherein the silica has a volume average particle size in the range 0.5 to 30 μm.

11. The aqueous slurry of claim 1 wherein the amount of silica present in the slurry is in the range 0.2 to 40 per cent by weight with respect to dry weight of crystalline aluminosilicate present.

12. The aqueous slurry of claim 1 in which the metal salt is a halide, a nitrate or a sulphate.

13. The aqueous slurry of claim 1 consisting essentially of the crystalline aluminosilicate, the salt of the second metal, the particulate silica and water.

14. A method for forming an aqueous slurry comprising
(a) from 20 to 50% by weight of crystalline aluminosilicate represented by the empirical formula
M_{2/n}O.Al₂O₃.xSiO₂.yH₂O
wherein M represents a first metal moiety, said first metal having a valency of n, x indicates the ratio of molecules of silica to molecules of alumina and y indicates the ratio of molecules of water to molecules of alumina,
(b) a salt of a second metal selected from the group consisting of Group III metals, metallic elements of Group IV, magnesium, titanium, chromium, iron, nickel, copper, zinc, zirconium and silver, said salt of a second metal being present in an amount which is sufficient to replace from about 2.0 to about 40 per cent by weight of the first metal moiety, and
(c) particulate silica having a BET surface area greater than 500 m²/g and a pore volume, as measured by nitrogen manometry of less than 2.1 cm³/g,
the method comprising mixing the crystalline aluminosilicate, the salt of the second metal and water in any order.

15. The method of claim 14 comprising forming a solution of the salt of the second metal at an appropriate concentration, adding the crystalline aluminosilicate with stirring thereto and subsequently adding the silica thereto, whilst stirring is continued.

16. The method of claim 14 wherein the aqueous slurry consists essentially of the crystalline aluminosilicate, the salt of the second metal and water.

17. The method of claim 14 wherein M is an alkali metal.

18. The method of claim 14 wherein M is sodium.
